(19) United States
(12) Patent Application Publication
(10) Pub. No.: US 2004/0159027 A1
(43) Pub. Date: Aug. 19, 2004

(54) Electronic display board supporting structure

(76) Inventors: Chul-Yong Kim, Anyang-si (KR); Jun-Hwa Jeong, Seoul (KR)

Correspondence Address: SHERIDAN ROSS PC, 1560 BROADWAY, SUITE 1200, DENVER, CO, 80202

(21) Appl. No.: 10/745,875

(22) Filed: Dec. 23, 2003

(30) Foreign Application Priority Data
Dec. 26, 2002 (KR) 2002-84490

(51) Int. Cl. G09F 1/00

(52) U.S. Cl. 40/612

(57) ABSTRACT

Disclosed is electronic display board supporting structure installed on perimeter road. The electronic display board supporting structure including: a main post having a base plate installed at a lower end part thereof to be uprightly coupled to a base concrete member; a main frame formed of a rectangular pipe material such that an electronic display board case frame for constructing an electronic display board and a side pole for supporting an electronic display board case have a combined structure to reduce a total area and weight when an electronic display board is installed; and a connection member horizontally extended from the main frame to couple the main frame with the main post.

### FIELD OF THE INVENTION

The present invention relates to an electronic display board supporting structure installed on perimeter road; and, more particularly, to an electronic display board supporting structure in which a main frame is integrally formed to allow an electronic display board case frame of an electronic display board and a side pole for supporting an electronic display board case to have a combined structure, thereby light-weighting the side pole and a main post.

### DESCRIPTION OF THE PRIOR ART

Generally, an electronic display board installed on perimeter road is a structure using a plurality of LED (light emitting diode) pixels to display a character or an image, and functions to inform a driver of various traffic environments such as a jamming section or accident news by a character.

A conventional supporting structure for supporting the electronic display board installed on perimeter road, as shown in FIGS. 1A and 1B includes: a main post 101 installed on perimeter road with a certain vertical directional length, and having a ladder iron core 101a mounted on an exterior surface at equal-interval and a flange plate 101b having a reinforcing plate installed at a lower end thereof; circular upper and lower side poles 102 and 102′ installed at a distance at upper and lower portions of an upper side of the main post 101 to pass through the main post 101; a connection bracket 103 for fixing the side poles 102 and 102′ to the main post 101; a vertical support pole 104 for maintaining an interval between the upper and lower side poles 102 and 102′; an electronic display board case 105 coupled to the side poles 102 and 102′ and having a certain area for supporting the electronic display board; and a suspension wire 106 fixed to a ring of the upper side pole 102 at one end thereof and fixed to a ring of the main post 101 at the other end thereof to suspend the side poles 102 and 102′.

Another example of the conventional electronic display board supporting structure is shown in FIGS. 2A to 2D.

Herein, the same elements as those of the supporting structure of FIGS. 1A and 1B are designated in the same reference numerals, and only different elements are briefly described.

The electronic display board supporting structure, as illustrated in the drawing, includes a cabinet holder 201 for holding an electronic display board controlling cabinet (not shown) at a lower portion of the post 101, a cable checking hole 202 for checking a communication cable, and a platform 203 installed at a rear lower portion of the electronic display board case 105 by a suspension type wire 204, for the maintenance and repair of the electronic display board.

Further, as shown in FIG. 2C, the electronic display board case 105 are coupled with the upper and lower side poles 102 and 102′ by a U-type bolt 205, and as shown in FIG. 2D, the main post 101 and the side poles 102 and 102′ are fixed to each other by a circular flange 206.

As described in the above example, the supporting structure installed on perimeter road to support the electronic display board should firmly support the electronic display board, and also a dynamic structure analysis should be made considering severe external environment such as a snowy wind and a rainy wind, particularly a strong wind load, and a construction work should be made on basis of the structure analysis.

However, in the conventional supporting structure, the electronic display board case 105 including the electronic display board is much weighted, for example, generally ranging from 1500 to 2000 kg. In order to support the weight, the side poles 102 and 102′ should necessarily have large-sized pipe diameters. Further, in order to support a total weight of the side poles 102 and 102′ and the electronic display board case 105 and endure the wind load thereof, the main post also has to have a large-sized pipe diameter. Furthermore, since a coupling location of the U-type bolt should be provided to fix the circular side pole to the electronic display board case by the U-type bolt, the electronic display board case should have a large-sized area (the electronic display board case generally has a spare width of 400 mm at an upper and lower side thereof and a spare width of 300 mm at left and right sides thereof from a location where the U-type bold is coupled), and as a result, the electronic display board case is much increased in area. Accordingly, the total weight of the supporting structure causes costs of the construction work to be increased excessively.

Furthermore, in order to enable the electronic display board to be structurally stably supported in a condition of the total weight and the wind load of the conventional supporting structure as described above, a base concrete 301 is, as shown in FIG. 2E, laid underground so that the main post can support the weight of the electronic display board on the base concrete.

The base concrete 301 is formed of a flat pedestal member 301a and a vertical member 301b erected upright on the pedestal member 301a and is buried in an inverse T shape. The main post 101 is seated on an upper surface of the vertical member 301b of the base concrete 301 such that the flange plate 101b installed at a lower end of the main post 101 is connected with the base concrete 301 by an anchor bolt and the like.

The inverse-T-shaped base concrete 301 should have enough area enough not to be escaped from the ground even though the electronic display board is subjected to the wind load caused by a strong wind, etc. The conventional base concrete 301 generally has the area of about 3000 mm and 2000 mm horizontally and vertically. Further, in order to manufacture the inverse-T-shaped base concrete 301, two processes are generally performed by a first process of laying the plate-shaped concrete supporting member 301a underground after base bar arrangement and curing the plate-shaped concrete supporting member 301a, and a second process of placing and curing a concrete after vertical-directional bar arrangement to the base bar arrangement. Accordingly, the conventional electronic display board supporting structure has a drawback in that it takes considerable time to manufacture the base concrete directly on the spot thereby causing the traffic jam at a perimeter road.

The conventional electronic display board supporting structure has a drawback in that the cost of the construction work is excessively spent, and the area of the base concrete is enough widely designed and constructed considering the total weight and the wind load of the supporting structure since the electronic display board case for supporting the electronic display board and the side pole for supporting the electronic display board case should have enough strength, and further the main post should have the large-sized pipe diameter for supporting the weight of the side pole and the electronic display board case including the electronic display board.

Further, the conventional electronic display board supporting structure has inconvenience in that installation cannot be made at a location which it should be installed on a traffic strategy since a buried object such as a gas pipe, a communication pipe, a soil pipe, a drain pipe and the like cannot be confirmed with one's eyes until being unburied directly on the spot, and an installation location should be frequently changed.

The electronic display board supporting structure has a drawback in that it takes a long time for its installation work.

Due to the above reasons, the conventional electronic display board supporting structure has a limit in that a base structure should have a length below 1500 mm in a perpendicular direction to the road such that construction can be made at one time at an appropriate location on the traffic strategy without trial and error.

### SUMMARY OF THE INVENTION

It is, therefore, an object of the present invention to provide an electronic display board supporting structure in which a case frame for constructing an electronic display board and a side pole for supporting an electronic display board case are integrated to have a combined structure such that a total weight and area of the electronic display board is reduced and that a moment is reduced for a wind direction thereby minimizing a burden applied to a main post.

It is another object of the present invention to provide an electronic display board supporting structure for minimizing a size of a base concrete laid underground in a perpendicular direction to a road (in a width direction of the road) due to weight-lightening of the electronic display board supporting structure thereby simply conveniently achieving a base ground work, and manufacturing a base concrete through one curing process in comparison with a conventional base concrete manufactured through two curing processes.

In accordance with one aspect of the present invention, there is provided an electronic display board supporting structure including: a main post having a base plate installed at a lower end part thereof to be uprightly coupled to a base concrete member; a main frame formed of a rectangular pipe material such that an electronic display board case frame for constructing an electronic display board and a side pole for supporting an electronic display board case have a combined structure to reduce a total area and weight when an electronic display board is installed; and a connection member horizontally extended from the main frame to couple the main frame with the main post.

The present invention further includes an auxiliary supporting unit having one end connected to an upper end part of the main frame and the other end connected to an upper end part of the main post such that the main frame is auxiliarily supported to be in a suspended state with respect to the main post.

Additionally, the main frame is formed of rectangular pipe materials such that the electronic display board is modularized into any one of two to ten equal-parts according to a size of the electronic display board to be installed and replaced by module, and the auxiliary supporting unit is a suspension wire having one end connected to the upper end of the main frame and the other end connected to the upper end of the main post.

Additionally, the present invention further includes a flange plate having a plurality of reinforcing plate for supporting the connection member provided at a through-pass location of the main post. The main frame further includes: a preventive member installed at a rear end part of the main frame to be across upper and lower parts every certain interval, for preventing the electronic display board to be escaped from the main frame; and a platform extensively installed at a rear lower end part of the main frame. The main post has a cable checking hole at a lower side part thereof and a cabinet holder at an upper part of the cable-checking hole.

In the meanwhile, the base concrete member is a rectangular concrete member having a vehicle forwarding direction part longer than a road width direction part, and the base concrete member is formed of an unreinforced concrete manufactured by humidity curing.

### BRIEF DESCRIPTION OF THE DRAWINGS

The above and other objects and features of the present invention will become apparent from the following description of the preferred embodiments given in conjunction with the accompanying drawings, in which:

FIGS. 1A and 1B are a front elevation view and a plane elevation view schematically illustrating a construction of a conventional electronic display board supporting structure;

FIGS. 2A and 2B are a front elevation view and a rear elevation view schematically illustrating a construction of a conventional electronic display board supporting structure;

FIG. 2C is a side elevation view illustrating a side pole and an electronic display board fixed thereto in a conventional electronic display board supporting structure;

FIG. 2D is a view depicting a structure in which a side pole is fixed to a main post in a conventional electronic display board supporting structure;

FIG. 2E is a view depicting a structure of a conventional concrete ground structure for supporting a main post;

FIGS. 3A and 3B are a front elevation view and a rear elevation view illustrating a construction of an electronic display board supporting structure in accordance with one embodiment of the present invention;

FIG. 3C is a side elevation view illustrating a state in which an electronic display board is fixed to an elementary side pole used as an electronic display board frame in an electronic display board supporting structure in accordance with the present invention;

FIG. 3D is a view illustrating a construction of a main post and a side pole coupled thereto in an electronic display board supporting structure in accordance with the present invention;

FIG. 3E is a view depicting a concrete ground structure for supporting a main post in accordance with the present invention; and

FIGS. 4A to 4D are diagrams for a structure analysis considering a wind direction and loading of an electronic display board supporting structure in accordance with the present invention.

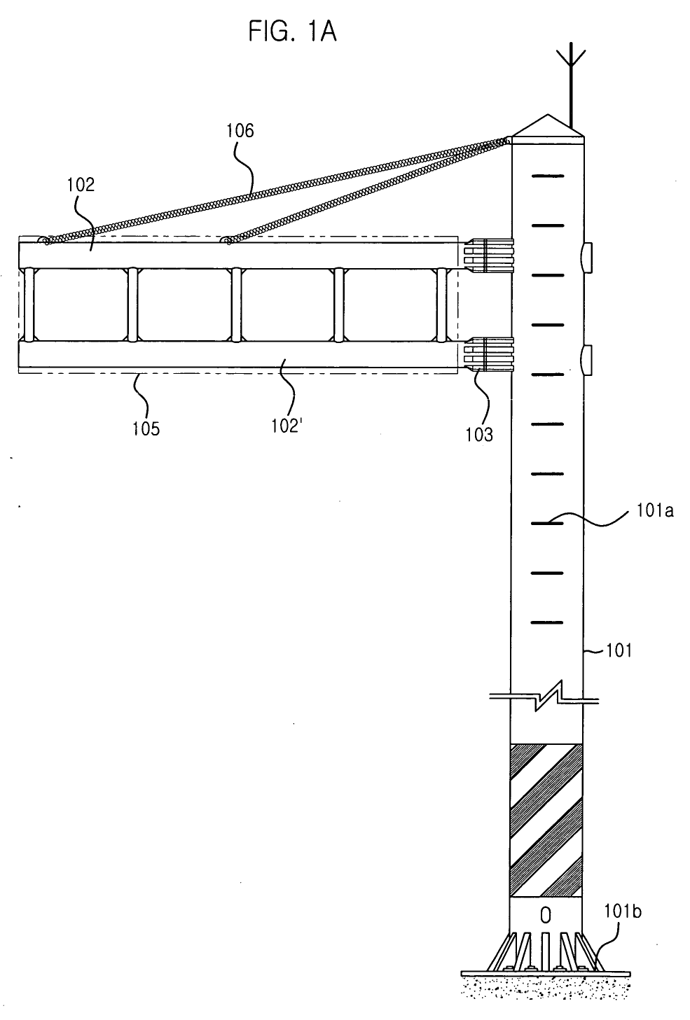

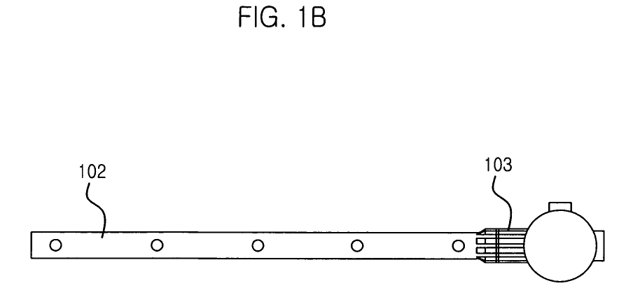

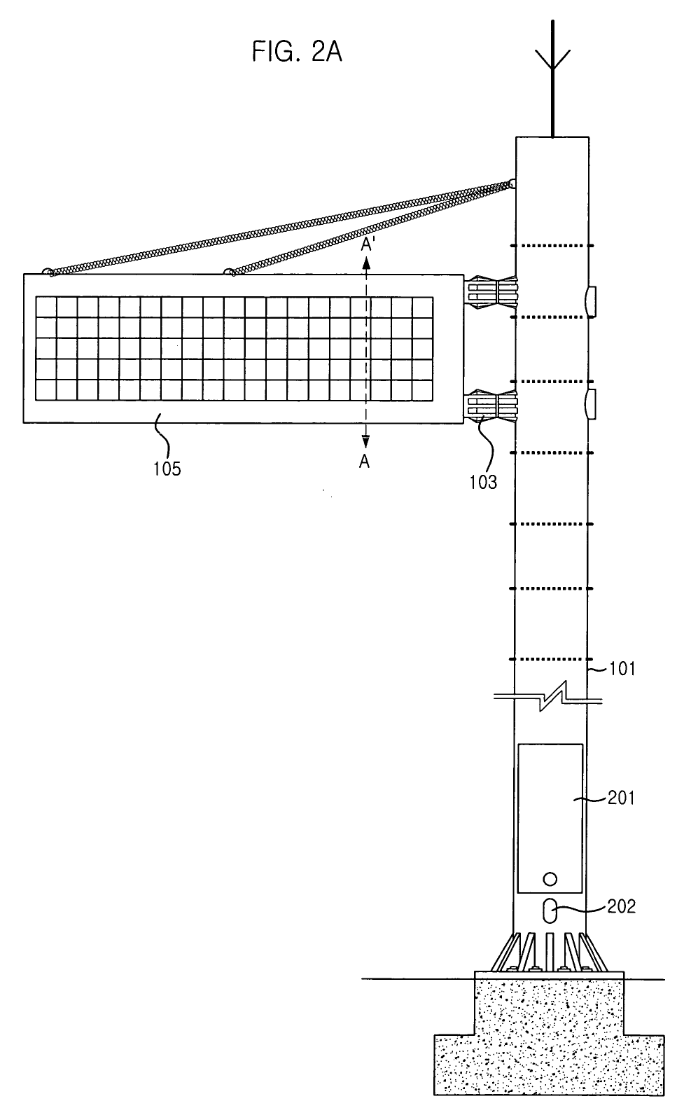

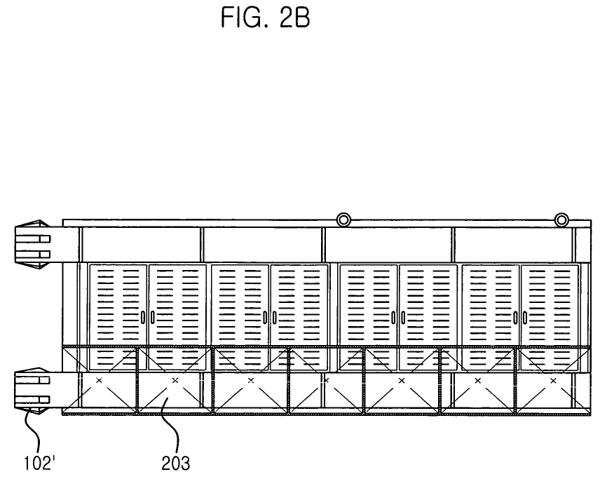

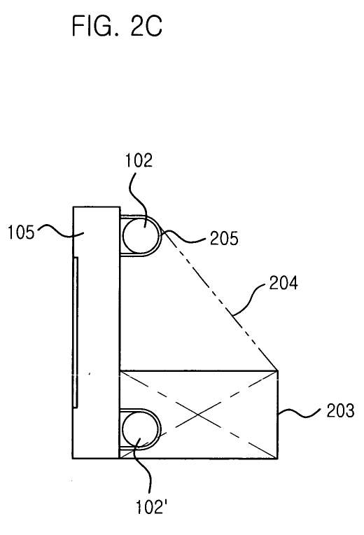

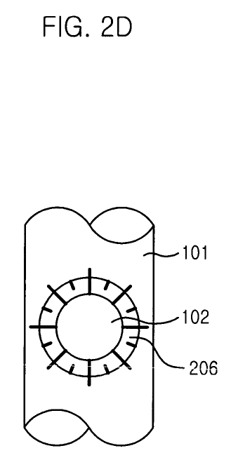

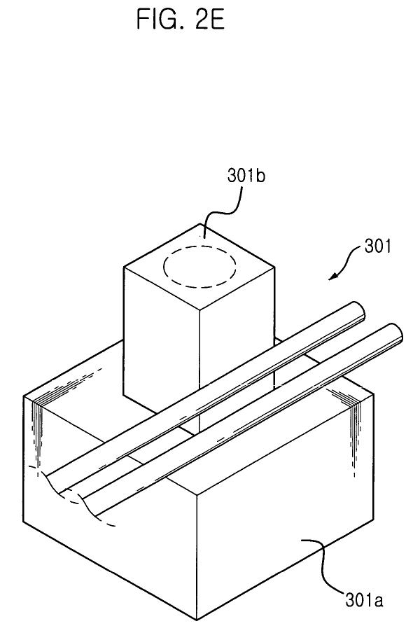

### DETAILED DESCRIPTION OF THE PREFERRED EMBODIMENTS

Reference will now be made in detail to the preferred embodiments of the present invention, examples of which are illustrated in the accompanying drawings.

An electronic display board supporting structure in accordance with the present invention is reduced in a total weight and area such that a burden applied to a main post is alleviated to cut down a material cost and an installation cost, etc. and to improve convenience and endurance of construction.

First, since a wind load resulting from the area and weight of the electronic display board is a factor for determining a kind selection and a shape or installation structure of a support member when the electronic display board is installed, the inventive electronic display board supporting structure has a main object for minimizing the wind load, and has an improved construction in which unnecessary parts can be omitted or a part of elementary construction can be used in two or more ways in the conventional electronic display board supporting structure. On basis of the above, the main post, the side pole and the like are determined in sectional diameters, a pipe is determined in thickness (t), and a base concrete is determined in shape and size.

For a reference, an electronic display board structure is constructed in three types such as a protrusive type, a gate type and a pattern type, and the present invention is adapted for the protrusive type and pattern type electronic display board structures.

On basis of the above condition, as shown in the drawings, the inventive electronic display board supporting structure includes a main post 2 for allowing a base plate 3 to be installed at a lower end part thereof to be upright-coupled onto a base concrete member 1, and having a coupling ring 2a provided at an upper end part thereof and a ladder iron core 2b installed at a certain interval (equal-interval) on a circumferential surface thereof; an electronic display board supporting frame 4 including a rectangular-sectional main frame 4a for fitting and supporting the electronic display board 10, I-type bolts 4b installed at a distance at an upper end part of the main frame 4a, a rectangular-sectional supporting foot 4c horizontally extended from upper and lower sides of one side surface of the main frame 4a and allowing an end part thereof to pass through an upper part of the main post 2, and a vertical frame 4d installed at a distance at a rear end part of the main frame 4a; and a suspension wire 5 having one end part thereof connected to the I-type bolt 4b of the electronic display board supporting frame 4, the other end part connected to a ring 2a of the main post 2, and a center part provided with a turn buckle (not shown), for suspending the electronic display board supporting frame 4 to the main post 2.

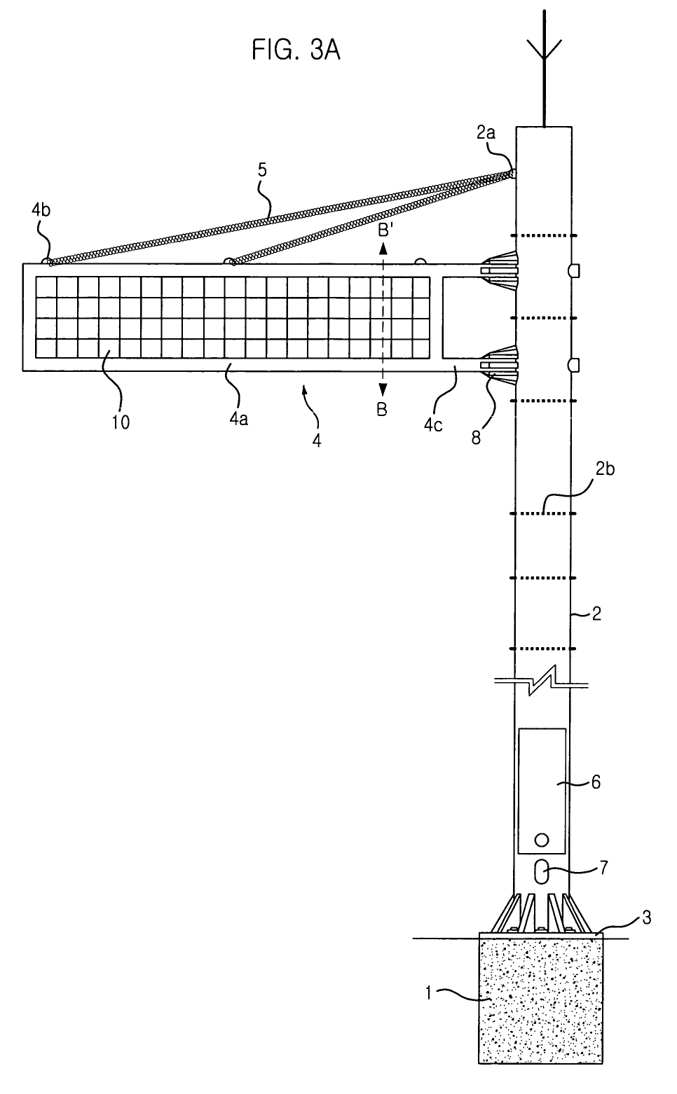

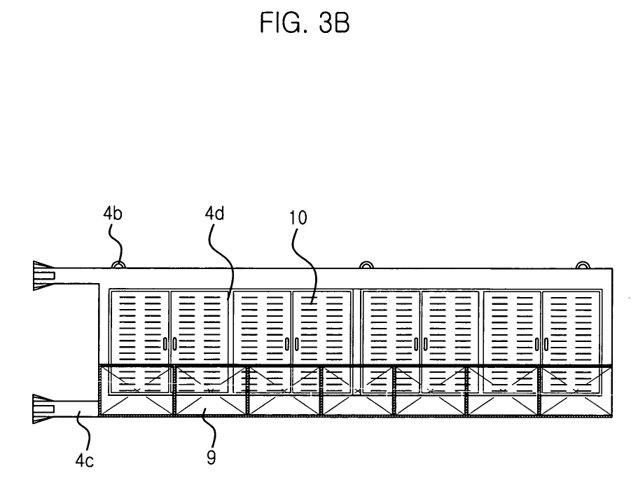

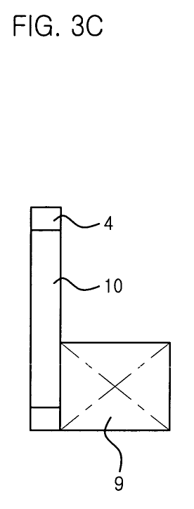

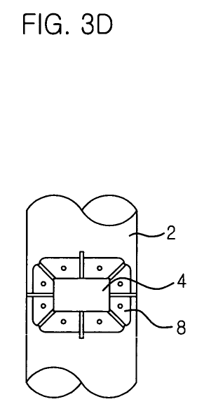

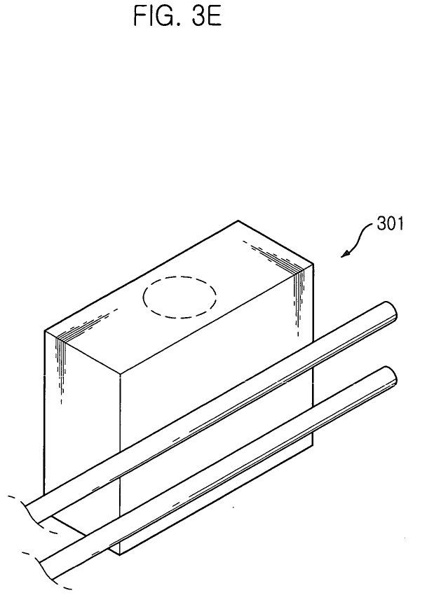

The main post 2 includes a cabinet holder 6 for the electronic display board at a lower part thereof, and a cable-checking hole 7 at a lower part side of the cabinet holder 6. Additionally, as shown in FIG. 3E, the base concrete member 1 is simply and conveniently laid underground while an underground space is secured enough for a communication cable, a power cable, a water pipe or a gas pipe, etc. that is laid underground.

Further, at the supporting foot 4c of the electronic display board supporting frame 4 is installed a flange 8 having a plurality of reinforcing plates such that the electronic display board supporting frame 8 is fixed to the main post 2, and a platform 9 is installed at a rear end part of the electronic display board supporting frame 4.

As shown in FIG. 3C, the main frame 4a and the supporting foot 4c of the electronic display board supporting frame 4 are shaped to have rectangular sections thereby providing a functional advantage for a combined use structure, and a good appearance. At this time, as shown in FIG. 3D, a main post 2 part having the rectangular-sectional supporting foot 4c passing therethrough is cut to have a rectangular section, and the flange 8 having a rectangular hole is fixed to the rectangular-sectional cut part of the main post 2.

As described above, the present invention constructs the electronic display board case frame and the side pole as one support body thereby reducing the total weight of a member for supporting the electronic display board. Accordingly, a construction work is easily performed due to reduction of a size of a section of the main post 2, and an advantageous design can be economically made.

In particular, since the present invention changes the conventional circular side pole into the rectangular side pole and uses the rectangular side pole as an outer case of the electronic display board, the electronic display board is sectioned into two or more parts for manufacture and installation depending on a size of the electronic display board. According to one embodiment of the present invention, it is desirable that the electronic display board is sectioned into two to ten parts depending on the size for modularization. Additionally, as described above, the side pole and the electronic display board frame have not only the combined structure thereby enable simple and convenient manufacture, but also the total area and weight influenced by the wind can be greatly reduced when the electronic display board is installed.

Further, reduction of the area and weight of the electronic display board supporting structure causes a moment for the wind direction to be reduced, the main post and the pipe are respectively reduced in the diameter and the thickness (t), and the base concrete member laid underground is not only reduced in area, but also accordingly, the electronic display board supporting structure can be constructed to have the improved endurance and to be harmonized with a good appearance of a city.

In the meanwhile, the inventive base concrete member 1 is formed of a rectangular-shaped concrete with a vehicle forwarding direction part being longer than a road width direction part, and has a basic standard calculated by reducing a basic width of the vertical direction to the road in consideration of interference of a ground object at the time of construction.

At this time, as the base concrete member 1, a structural unreinforced base concrete can be used due to the weight-lightness of the electronic display board supporting frame 4 and a section reduction of the main post 2. As shown in FIG. 3E, the underground space for other installations can be not only secured easily, but also an improved effect on construction work can be obtained such as reduction of construction term. At this time, in case the-unreinforced base concrete is installed, it is desirable that humidity curing is performed for preventing a crack caused by a hydrated heat when the concrete is cured.

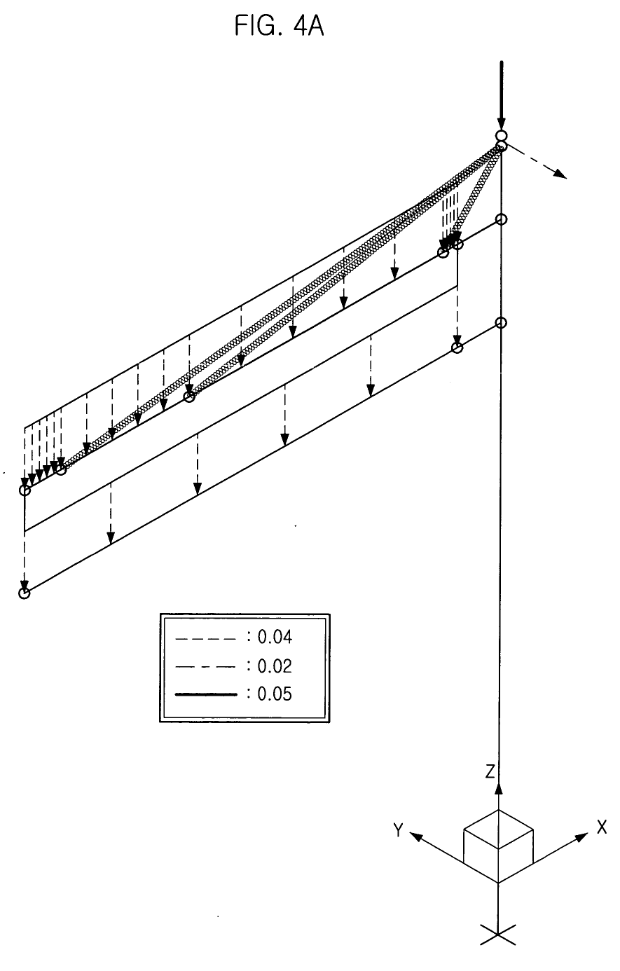

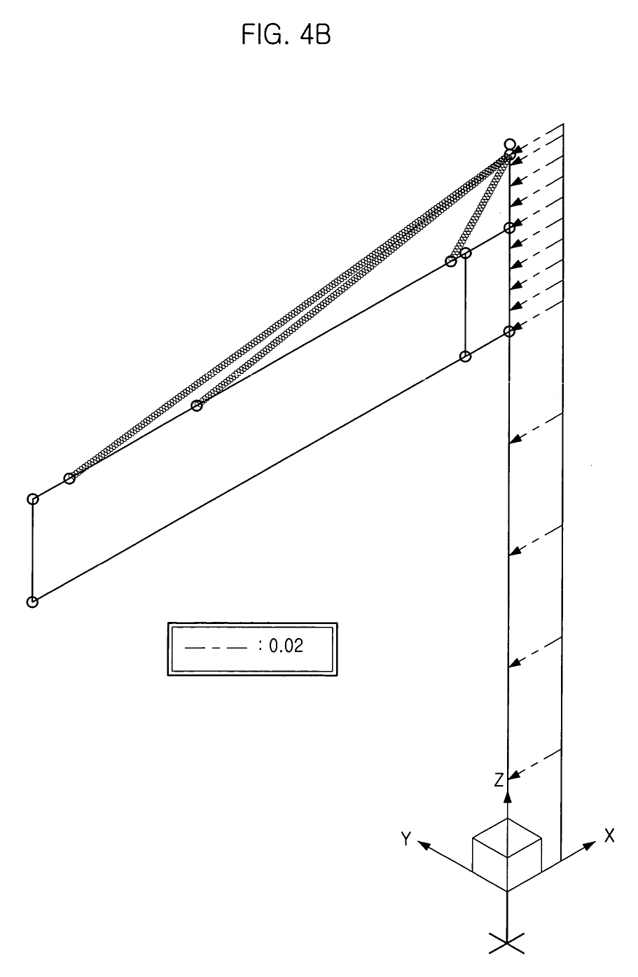

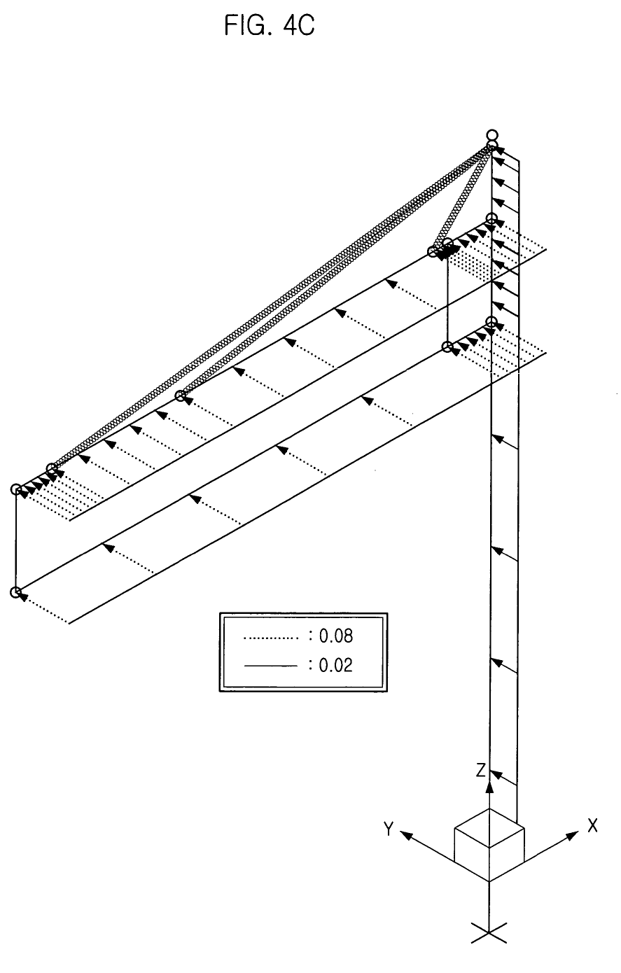

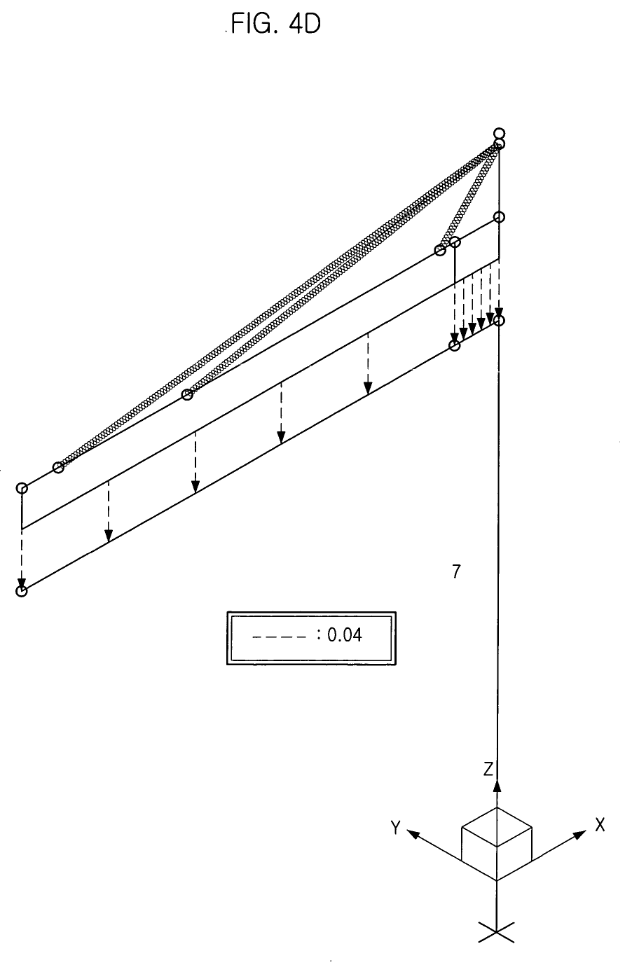

An example of a structure analysis for the present invention constructed above will be briefly described with reference to FIGS. 4A to 4D.

FIG. 4A is a diagram for checking a structure analysis according to loading of the electronic display board, FIG. 4B is a diagram for checking a structure analysis at the time of a cross wind affected on the electronic display board and the main post, FIG. 4C is a diagram for checking a structure analysis at the time of a head wind affected on the electronic display board and the main post, and FIG. 4D is a diagram for checking a structure analysis according to work loading.

The structure analysis of the inventive electronic display board supporting structure is based on assumptions that a basic wind velocity (V) is 50 m/sec firstly considering a self-load, a wind load, and a work load at the time of maintenance and secondly considering a structural importance and an endurance period, etc. for the wind load. Specifically, since the wind load is affected on the electronic display board in one direction, however is affected on the main post 2 in two-axis directions (a road width direction (X-axis) and a vehicle forwarding direction (Y-axis)), a stress and a basic design of the main post is structurally checked with respect to the work loading of two-axis directions.

Under the above assumptions, the loading of the electronic display board is, as shown in FIG. 4A, calculated as 0.4 ton to be is sectioned into two parts of an upper member and a lower member of the main frame 4a being a structural element of the electronic display board supporting frame 4 for vertical equal-loading, and the self load is automatically calculated in program.

In other words, the self load of the electronic display board supporting frame 4 is calculated by summing-up a dead load and other loads (considering a load of a velocity sensing camera), and the self load is calculated to be sectioned into two parts of the upper and lower horizontal members of the main frame 4a for vertical equal-loading.

Next, the wind load affected on the electronic display board is, as shown in FIGS. 4B and 4C, sectioned for equal-loading into the cases of the cross wind and the head wind. In case of the cross wind, an upwind pressure for a circular member is calculated to be equal-loaded on the main post. In case of the head wind, an upwind pressure for an angular member is calculated to be sectioned for horizontal equal-loading into two parts of the upper and lower horizontal members of the main frame 4a. The upwind pressure affected on the main post 2 is equal-loaded applying the case of the circular member.

FIG. 4D illustrates the structure analysis at the time of the work loading that should be considered for maintenance. The structure analysis is calculated having a working load resulting from two workers and a working position as a lower-end horizontal member being at a working foothold position.

As described above, the main frame is integrated to allow the electronic display board case frame for constructing the electronic display board and the side pole for supporting the electronic display board case to have the combined structure, the conventional circular side pole is changed into the rectangular side pole in a sectional shape of the side pole, and the rectangular side pole is used as an outer case of the electronic display board. Accordingly, the present invention has an effect in that the electronic display board and the side pole do not need to be combined by separately providing the U-type bolt, and the electronic display board is sectioned into a plurality of equal-parts (for example, three equal-parts, four equal-parts, six equal-parts and the like) such that modularization is possible and manufacture is not only simplified and convenient, but also the total area and weight affected by the wind can be greatly reduced.

Specifically, the inventive electronic display board supporting structure can be constructed such that a moment for the wind direction is reduced due to reduction of the area and weight thereof, the main-post and the pipe are respectively reduced in the diameter and the thickness (t), and the area of the base concrete is reduced. Accordingly, the present invention has an effect in that the electronic display board can be slimmed and harmonized with the good appearance of the city, and the total construction is simplified and convenient, and a material cost can be reduced.

Further, the electronic display board supporting frame is weight-lighted and the main post is reduced in diameter and thickness. Accordingly, the present invention has an effect in that the basic concrete member can be formed of the plate-shaped base not the conventional inverse-T shape, and can be unreinforced, and the area of the road width direction can be reduced to thereby simply achieve the construction.

Additionally, the present invention has an effect in that in a structural aspect, the base can be large-sized in the horizontal direction to the road thereby to increase a safety for the wind direction, whileas the base can be small-sized in the vertical direction to the road to thereby secure enough the underground space for installation.

While the present invention has been described with respect to the particular embodiments, it will be apparent to those skilled in the art that various changes and modifications may be made without departing from the scope of the Invention as defined in the following claims.

What is claimed is:

1. An electronic display board supporting structure comprising:
a main post having a base plate installed at a lower end part thereof to be uprightly coupled to a base concrete member;
a main frame formed of a rectangular pipe material such that an electronic display board case frame for constructing an electronic display board and a side pole for supporting an electronic display board case have a combined structure to reduce a total area and weight when an electronic display board is installed; and
a connection member horizontally extended from the main frame to couple the main frame with the main post.

2. The electronic display board supporting structure as recited in claim 1, further comprising an auxiliary supporting means having one end connected to an upper end part of the main frame and the other end connected to an upper end part of the main post, such that the main frame is auxiliarily supported to be in a suspended state with respect to the main post.

3. The electronic display board supporting structure as recited in claim 1, wherein the main frame is formed of rectangular pipe materials such that the electronic display board is modularized into any one of two to ten equal-parts according to a size of the electronic display board to be installed and replaced by module.

4. The electronic display board supporting structure as recited in claim 2, wherein the auxiliary supporting means is a suspension wire having one end connected to the upper end of the main frame and the other end connected to the upper end of the main post.

5. The electronic display board supporting structure as recited in claim 1, further comprising a flange plate having a plurality of reinforcing plate for supporting the connection member provided at a through-pass location of the main post.

6. The electronic display board supporting structure as recited in claim 3, wherein the main frame includes:
a preventive member installed at a rear end part of the main frame to be across upper and lower parts every certain interval, for preventing the electronic display board to be escaped from the main frame; and
a platform extensively installed at a rear lower end part of the main frame.

7. The electronic display board supporting structure as recited in claim 1, wherein the main post has a cable checking hole at a lower side part thereof and a cabinet holder at an upper part of the cable checking hole.

8. The electronic display board supporting structure as recited in claim 1, wherein the base concrete member is a rectangular concrete member having a vehicle forwarding direction part longer than a road width direction part.

9. The electronic display board supporting structure as recited in claim 8, wherein the base concrete member is formed of an unreinforced concrete manufactured by humidity curing.
